(19) United States
(12) Patent Application Publication
(10) Pub. No.: US 2010/0128556 A1
(43) Pub. Date: May 27, 2010

(54) APPARATUS AND METHODS FOR PRODUCING A BEVERAGE FROM LIQUID CONCENTRATE

(76) Inventor: Emil Shultis, Leeds, NY (US)

Correspondence Address: HESLIN ROTHENBERG FARLEY & MESITI PC, 5 COLUMBIA CIRCLE, ALBANY, NY, 12203, US

(21) Appl. No.: 12/596,199

(22) PCT Filed: Apr. 16, 2008
(86) PCT No.: PCT/US08/60460

§ 371 Date: Jan. 26, 2010

Related U.S. Application Data
(60) Provisional application No. 60/911,918, filed on Apr. 16, 2007.

(51) Int. Cl. A47J 31/44; A47J 31/00; A47J 31/60; B01F 15/00; B01F 15/02; B01F 15/04; B01F 15/06

(52) U.S. Cl. 366/138; 99/295; 99/302 R; 99/290; 99/288; 366/139

(57) ABSTRACT

An apparatus includes a tank for holding the diluent and a dispensing assembly. A pump is disposed in fluid communication with the tank and the dispensing assembly for supplying pressurized diluent to the dispensing assembly. An enclosure is provided having a sealable chamber for containing a concentrate container in fluid communication with the dispending assembly. An air pump pressurizes the sealable chamber and concentrate container to pressurize the liquid concentrate and supply the pressurized liquid concentrate to the dispensing assembly. The dispenser assembly is operable to permit and inhibit the flow of pressurized liquid concentrate and pressurized diluent to produce the beverage.

### CROSS-REFERENCE TO RELATED APPLICATION

This application claims the benefit of U.S. Provisional Application No. 60/911,918 filed Apr. 16, 2007, entitled “Apparatus And Methods For Producing a Beverage From Liquid Concentrate”, which is hereby incorporated in its entirety herein by reference.

### FIELD OF THE INVENTION

The present invention relates to apparatus and methods for producing beverages, and more specifically, to apparatus and methods for producing beverages from liquid concentrate.

### BACKGROUND OF THE INVENTION

Many beverages have been produced from concentrate including fruit juices, coffee, and tea. However, the production of coffee and tea from concentrate has been limited substantially to commercial devices that are expensive and cumbersome for home or office usage.

An example of a beverage apparatus that produces beverages from two liquid components is shown in the U.S. Pat. No. 3,843,020 issued to Bardeau. The beverage apparatus in Bardeau includes a spring for raising a carton containing the concentrate to control the flow rate of the concentrate. U.S. Pat. No. 3,532,505 to Cornelius discloses a coffee dispensing machine which utilizes a carbonated coffee concentrate. Another example, U.S. Pat. No. 6,752,069 issued to Burke et al. discloses adding water, either manually or automatically, to a beverage concentrate.

U.S. Pat. No. 4,579,048 issued to Stover discloses initially brewing a concentrate, specifically from tea leaves, to produce a concentrate. The concentrate is then diluted to an acceptable strength and temperature by the timed addition of water. U.S. Pat. No. 6,149,035 issued to Gorski et al. discloses using a dry concentrate for dispensing a food or beverage.

U.S. Pat. No. 3,536,496 issued to Paoloni discloses a method for producing concentrate and then using such concentrate for producing coffee. U.S. Pat. No. 5,740,719 issued to Triola et al. discloses a coffee maker using liquid coffee concentrate and a plunger to deliver the concentrate.

Vitality Foodservice, Inc. of Tampa, Florida offers dispensers for coffee and hot beverages. The device includes a solenoid valve for controlling discharge of water from a water tank to an open channel. Disposed above the open channel is a control valve for controlling discharge of concentrate into the water in the channel. The resulting beverage is then discharged.

U.S. Patent Application Publication No. 2006/0000851 by Girard et al. discloses a liquid concentrate/extract beverage dispenser with a replaceable concentrate/extract cartridge. The dispenser includes a housing having a dispensing area. A pump or a control valve is in communication with a source of diluent which is to be dispensed into the dispensing area. A cartridge receiving area and a dispensing actuator are located in the housing. A concentrate/extract cartridge is removably insertable into the cartridge receiving area in a position to be actuated by the dispensing actuator, the concentrate/extract cartridge being adapted to hold a beverage concentrate/extract and includes a dispensing aperture for dispensing a beverage concentrate/extract into the dispensing area upon placement of the concentrate/extract cartridge in the cartridge receiving area. A controller is located in the housing to control the actuator to discharge concentrate/extract into the dispensing area.

Aroma Housewares Company of San Diego, Calif. manufactures a Hot Water Pump Pot, model number AAP-325F, which is an electric kettle that heats up water for instant coffee or soup without a stove or hot plate, and features an automatic dispensing button and a safety lock.

There is a need for further apparatus and methods for producing a beverage from liquid concentrate.

### SUMMARY OF THE INVENTION

The present invention provides, in a first aspect, an apparatus for producing a beverage from a liquid concentrate in a concentrate container and a diluent. The apparatus includes a tank for holding the diluent, and a dispensing assembly. A pump is provided in fluid communication with the tank and the dispensing assembly for supplying pressurized diluent to the dispensing assembly. An enclosure is provided having a sealable chamber for containing a concentrate container in fluid communication with the dispending assembly. An air pump pressurizes the sealable chamber and concentrate container to pressurize the liquid concentrate and supply the pressurized liquid concentrate to the dispensing assembly. The dispenser assembly is operable to permit and inhibit the flow of pressurized liquid concentrate and pressurized diluent to produce the beverage.

The present invention provides, in a second aspect, a method for producing a beverage from a liquid concentrate and a diluent. The method includes providing a tank having the diluent, sealing a concentrate container containing the liquid concentrate in an airtight enclosure, pressurizing air in the airtight enclosure and around the concentrate container, pressurizing the diluent, transferring pressurized diluent and pressurized liquid concentrate to a dispensing assembly, and selectively permitting and inhibiting the flow of pressurized liquid concentrate and pressurized diluent from the dispensing assembly to produce the beverage.

### BRIEF DESCRIPTION OF THE DRAWINGS

The present matter which is regarded as the invention is particularly pointed out and distinctly claimed in the concluding portion of the specification. The present invention, however, may best be understood by reference to the following detailed description of various embodiments and the accompanying drawings in which:

FIG. 1 is a perspective view of one embodiment of an apparatus for producing a beverage from liquid concentrate and a diluent in accordance with the present invention;

FIG. 2 is a top view of the apparatus of FIG. 1;

FIG. 3 is a side elevations view, partially cut away, showing portions of the interior of the apparatus of FIG. 1;

FIG. 4 is an enlarged, side elevational view, partially cutaway, of the dispenser assembly of FIG. 1 shown in the configuration for dispensing the beverage;

FIG. 5 is an enlarged view of the liquid concentrate metering valve of FIG. 1;

FIG. 6 is an enlarged view of the cleaning valve of FIG. 1 for cleaning the liquid concentrate conduit when the liquid concentrate bag is empty;

FIG. 7 is an enlarged, side elevational view, partially cutaway, of the dispenser assembly of FIG. 1 shown in the configuration for cleaning the concentrate conduit; and

FIG. 8 is a circuit diagram of the electrical components of the apparatus of FIG. 1.

### DETAILED DESCRIPTION OF THE INVENTION

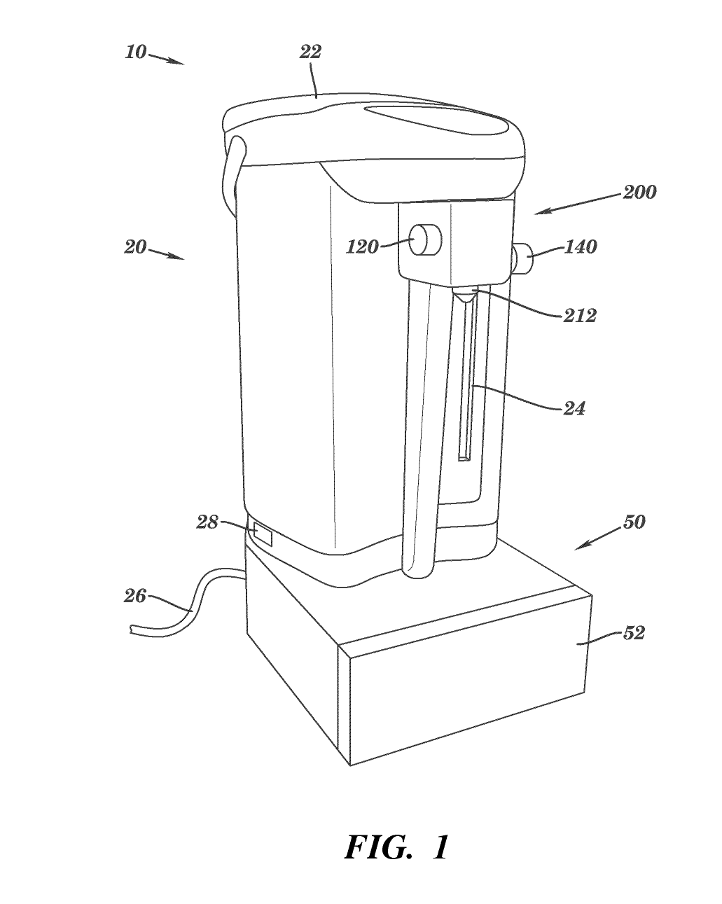

With reference to FIG. 1, an apparatus 10 is shown for producing a beverage from a liquid concentrate and a diluent. In this embodiment apparatus 10 may produce coffee from heated water and liquid coffee concentrate. From the present description, it will also be appreciated that tea, soup, and other beverages may be produced using apparatus 10.

Generally, apparatus 10 includes a housing 20, a lid 22 shown in a closed or lowered position, a base 50 for containing a liquid concentrate bag, and a dispensing assembly 200. The lid is hinged at the back, and the front may be rotated upwardly to gain access into the housing. For example, a user may raise the lid to pour water into the housing. In addition, the housing may include a level indicator 24 for indicating the level of the liquid such as water in the apparatus. Electrical power may be supplied by an electical cord 26 which may include a plug for conntecting the cord to an eletical outlet such as a 120-vole alternating current outlet in a home of office. A power on/off switch 28 allows a user to turn on and off electrical power to apparatus 10.

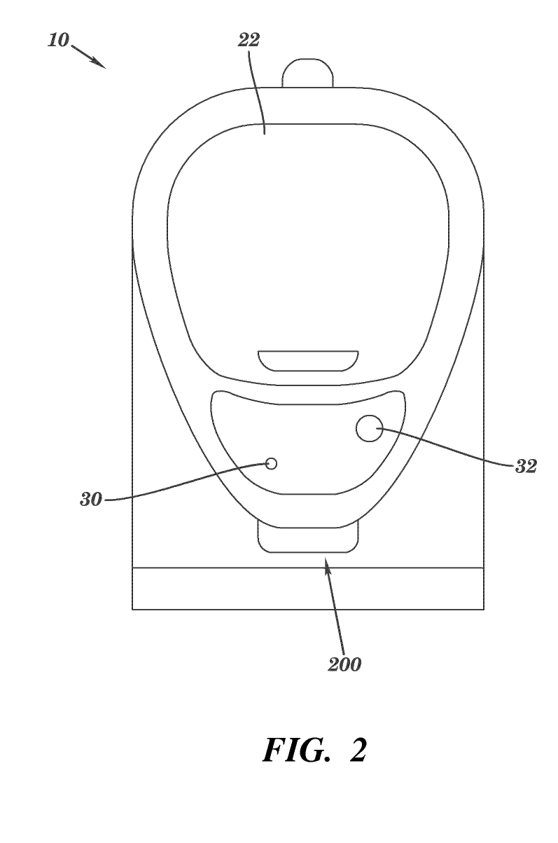

As shown in FIG. 2, the top of apparatus 10 may include an indicator 30 such as a green light for indicating when the liquid such as water in the apparatus is heated to the desired temperature. An electrical push button 32 may be provided which when pressed discharges the beverage from the dispensing assembly 200. In addition, electrical push button 32 when pressed may allow for cleaning the liquid concentrate tube and portion of the dispensing valve as described in greater detail below.

With reference again to FIG. 1, dispensing assembly 200 may include an adjustable liquid concentrate metering valve 120, a cleaning valve 140 for allowing a liquid concentrate conduit to be cleaned, and a dispensing outlet 160.

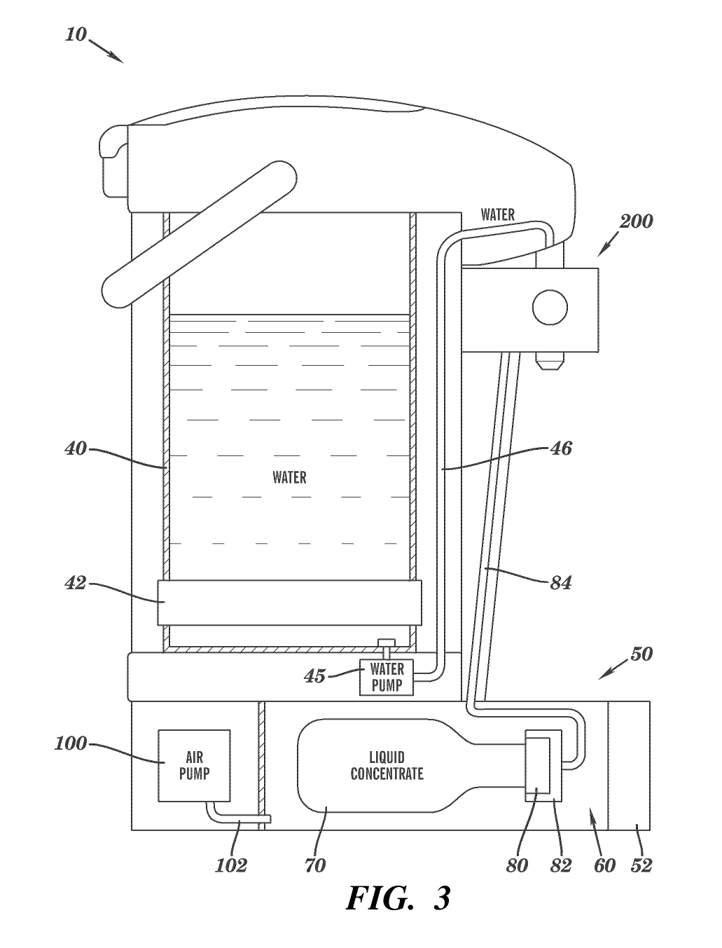

As best shown in FIG. 3, disposed within apparatus 10 is a container or tank 40 such as a stainless steel container for receiving water. A heating element 42 such as a heating band may be disposed around the bottom of the container for heating the water to an elevated temperate. For example, the water may be heated to about 150 degrees Fahrenheit to about 190 degrees Fahrenheit, or higher. A water pump 45 is provided for pumping water from container 40 through a conduit 46 to dispensing assembly 200.

An enclosure or base 50 may include a hinged door 52 which when opened allows access to a chamber 60. A gasket may be provided which when door 52 is closed creates sealed chamber 60. Disposed in chamber 60 is a concentrate container or flexible bag 70 that collapses as concentrate is consumed as described below. The flexible bag 70 is inexpensive and once emptied may be readily disposed, and as descried below, may be used for cleaning the liquid concentrate tube and other portions of the apparatus. The liquid concentrate bag may be a Raypac bag having a fitting which connects to a concentrate conduit 84 via mating connectors 80 and 82. Both the connectors may have a check valve which when the two are connected, the check valves are disposed in an open position. When the two are separated, both check valves are closed.

Also disposed in base 50 in is an air pump 100. The air pump may be connected to a tube 102 for supplying pressurized air to chamber 60. The air pump 100 provides a low positive pressure in sealed chamber 60, of about 0.5 pounds per square inch (psi) to about 15 psi, and desirably about 2 psi to about 10 psi, around flexible bag 70. The air pump may be operably connected to the electrical power supply to pressurize the air surrounding the flexible bag 41 when the water is at the desired temperature. Alternatively, the apparatus may be configured so that upon initially turning on the apparatus, the air pump is activated to pressurize the air surrounding the flexible bag. Pressurized liquid concentrate travels via concentrate conduit 84 from flexible bag 70 to dispensing assembly 200.

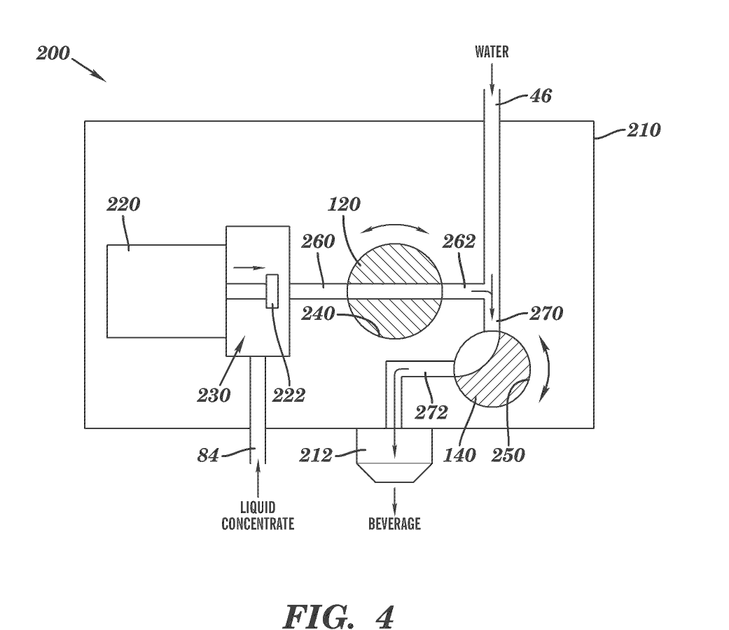

FIG. 4 is an enlarged, side elevational view, partially cutaway, of dispensing assembly 200. Dispenser assembly 200 includes a housing 210, a solenoid valve 220 having a stopper 222 which may be operably connected to dispensing push button 32 (FIG. 2), a reservoir 230 for receiving liquid concentrate from conduit, a first passageway 240 for receiving liquid concentrate metering valve 120, and a second passageway 250 for receiving cleaning valve 140 for cleaning liquid concentrate conduit 84.

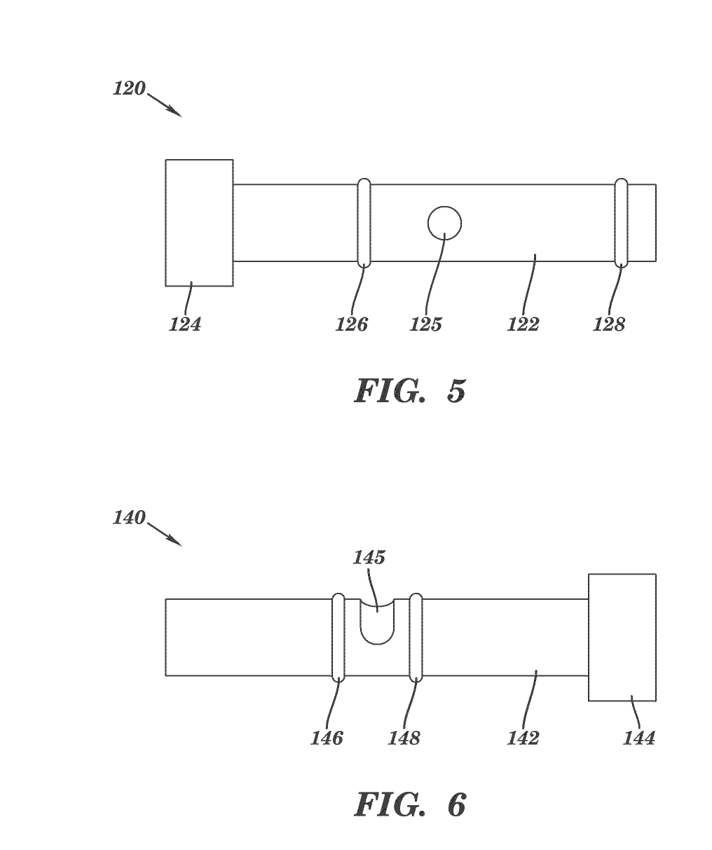

FIG. 5 further illustrates liquid concentrate metering valve 120 which may include a cylindrical portion 122 having enlarged knob 124 and two O-rings 126 and 128. Disposed between the O-rings is a passageway 125. With reference again to FIG. 4, valve 120 may be disposed so that passageway 125 is aligned with passageways 260 and 262 in dispenser housing 120. Upon rotating knob 124, passageway 125 will be moved out of alignment with passageways 260 and 262 thereby reducing the flow of liquid concentrate through metering valve 120 and reducing the strength of the resulting beverage compared to when passageway 125 is aligned with passageways 260 and 262.

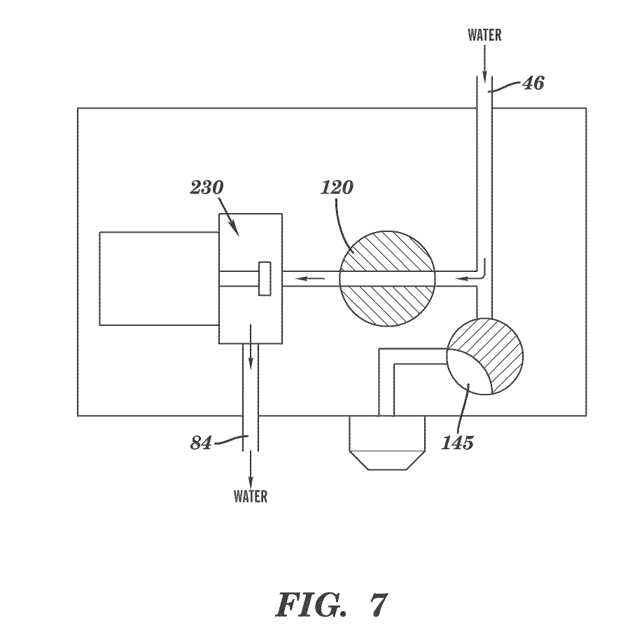

FIG. 6 further illustrates valve 140 for cleaning the liquid concentrate conduit which may include a cylindrical portion 142 having enlarged knob 144, and two O-rings 146 and 148. Disposed between the O-rings is a cutout 145. With reference again to FIG. 4, valve 140 is disposed so that cutout 145 is aligned with passageways 270 and 272 in dispenser housing 200 to allow the combination of water and liquid concentrate to flow to dispensing outlet 212. When flexible bag 70 is empty of liquid concentrate, rotating knob 144 may be rotated so that cutout 145 is moved out of alignment with passageways 270 and 272, as shown in FIG. 7, thereby blocking the flow of fluid to dispensing outlet 212. Upon pressing discharge button 32 and with the water pressure in conduit 46 having a greater pressure than the pressure in conduit 46 (the air pump may remain on or may be operably shut off), water will be made to travel through metering valve 120, through reservoir 230, conduit 84, and into flexible bag 70 (FIG. 3) which flexible bag 70 may then be disposed. For example, the cleaning of the liquid concentrate reservoir 230 and conduit 84 may take about a few seconds to a minute.

In addition, it is noted that bending or changing of the directions of the conduit 270 and 272, and including valve 140, aids in mixing of the two components for producing the beverage.

While the described apparatus 10 is typically filled with water by a user using, for example, a pot or other container, it will be appreciated that the apparatus may be operably connected to a water supply line (such as from a water supply in a home or building). For example, a suitable fill valve maybe located in the supply line and a suitable float valve may be located in the container.

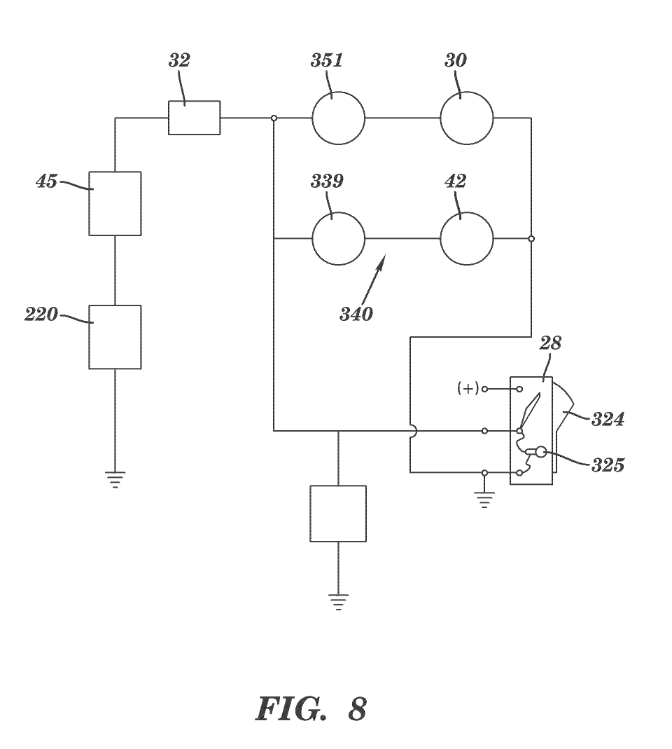

As shown in FIG. 8, a schematic electrical diagram of the electrical circuit in apparatus 10 may include an illuminated on/off rocker switch 28 operably attached to a source of electrical power, e.g., a one-hundred-ten volt alternating current outlet in a home or building. With the switch 28 turned on, a light 325 is turned on and illuminates a red actuator 324 to alert the user that power is being supplied to the apparatus. In the “on” position and if sufficient water is in the water tank, electrical power is supplied to an electric circuit 340 comprising a thermo button or temperature sensor 339 and a heating element 42 such as a heating band. The temperature sensor 339 may be attached directly to the water tank (FIG. 3) to measure the temperature of the water. If the water is cold, the temperature sensor 339 allows electrical current to be supplied to the heating element 42. When temperature sensor 339 detects the water getting too hot, it cuts off the current to the heating element. When the water cools down, the temperature sensor turns the heater back on. By cycling on and off, the temperature sensor keeps the coil at an even temperature to heat the water in the tank. For safety in the event that the temperature sensor 339 fails, one or more thermal fuses may be employed to cut power if the thermal fuses sense the heat in reaching too high a temperature. When the desired temperature of the water is achieved as detected by a second thermal button or temperature sensor 351, an indicator 30 such as a green light is illuminated to alert a user that the water is at the desired temperature for making the beverage. If the water temperature drops, for example when pouring in more water, the light 350 would go out and remain out until the water returns to the desired temperature. As described earlier, the apparatus may include a heating element, however, a cooling element for producing cold beverages may be suitably employed.

In operation, when a beverage is desired, dispensing button 32 may be pressed, which operably supplies electric power to water pump 45 and activates solenoid 220 to allow discharge of liquid concentrate as described above. Both the water and liquid concentrate may be made to flow at constant rates. An added benefit due to the positive pressure is that the flexible bag 70 will completely empty, e.g., there will be little if any concentrate left in the flexible bag.

In addition, by closing the strength valve (FIG. 4), no liquid concentrate will be delivered from the dispenser outlet so as to provide only hot water where a heating element is employed or cold water where a cooling element is employed.

The various features of the Aroma Hot Water Pump Pot model number AAP-325F may be employed and incorporated into the present invention. Additional features disclosed in U.S. patent application Ser. No. 11/145,720, filed Jun. 6, 2005, entitled “An Apparatus For Producing A Beverage” and International Patent Application PCT/US06/00238 published as WO 2006/083473 may be incorporated into the present invention. The entire subject matter of these applications are incorporated herein by reference.

Furthermore, to reduce the risk of shock to a user, a relay or relay board may be employed to control a reduced electrical supply to activate the solenoid for controlling the discharge of liquid concentrate, the air pump, and/or the water pump. In addition, an apparatus in accordance with the present invention may include connecting the apparatus to a supply of water such as in a home or building, and also providing multiple dispensing heads (such as 4 dispensing heads). Each of the dispensing heads may further be configured to provide for dispensing hot water or unheated water, i.e., employing a plurality of solenoids and suitable relays. Unheated water may be used in combination with a supply of liquid tea concentrate. Ice cubes can be added to the resulting beverage to produce iced tea.

While various embodiments of the present invention have been illustrated and described, it will be appreciated to those skilled in the art that many changes and modifications may be made thereunto without departing from the spirit and scope of the invention.

1. An apparatus for producing a beverage from a liquid concentrate in a concentrate container and a diluent, the apparatus comprising:
a tank for holding the diluent;
a dispensing assembly;
a pump in fluid communication with the tank and the dispensing assembly for supplying pressurized diluent to said dispensing assembly;
an enclosure having a sealable chamber for containing the concentrate container in fluid communication with the dispensing assembly;
an air pump for pressurizing said sealable chamber and the concentrate container to pressurize the liquid concentrate and supply pressurized liquid concentrate to said dispensing assembly; and
wherein said dispensing assembly is operable to permit and inhibit the flow of pressurized liquid concentrate and pressurized diluent to produce the beverage.

2. The apparatus of claim 1 wherein said diluent comprises water, said pump comprise a water pump, and said concentrate container comprises liquid coffee concentrate.

3. The apparatus of claim 1 wherein said dispensing assembly comprises a liquid concentrate metering valve for adjusting the flow of liquid concentrate through the dispensing assembly.

4. The apparatus of claim 1 further comprising a concentrate conduit connecting said concentrate container to said dispensing unit, and wherein said dispensing assembly comprises a cleaning valve for directing diluent through said concentrate conduit to clean said concentrate conduit.

5. The apparatus of claim 1 further comprising a concentrate conduit connecting said concentrate container to said dispensing unit, and wherein said dispensing assembly comprises a cleaning valve having a first position for permitting discharge of liquid concentrate and diluent from a discharge outlet to produce the beverage, and a second position where discharge from said discharge outlet is inhibited and diluent is directing through said concentrate conduit.

6. The apparatus of claim 1 further comprising a concentrate conduit connecting said concentrate container to said dispensing unit, and wherein said dispensing assembly comprises a cleaning valve, and wherein said cleaning valve has a cutout which when the cleaning valve is rotated and aligned in a first position connects a passageway in the dispensing assembly to a discharge outlet to permit discharge of liquid concentrate and diluent from a discharge outlet to produce the beverage, and when rotated and disposed in a second position, discharge from said discharge outlet is inhibited and diluent is directing through said concentrate conduit.

7. The apparatus of claim 1 wherein said dispensing assembly comprises a solenoid valve for controlling the discharge of concentrate into a discharge outlet.

8. The apparatus of claim 1 further comprising a thermal element for maintaining the diluent at a predetermined temperature.

9. The apparatus of claim 8 wherein the thermal element comprises a heating element for maintaining the diluent at an elevated temperature.

10. The apparatus of claim 1 wherein the concentrate container comprises a flexible bag.

11. A method for producing a beverage from a liquid concentrate and a diluent, the method comprising:
providing a tank comprise the diluent;
sealing a concentrate container containing the liquid concentrate in an airtight enclosure;
pressurizing air in the airtight enclosure and around the concentrate container;
pressurizing the diluent;
transferring pressurized diluent and pressurized liquid concentrate to a dispensing assembly; and
selectively permitting and inhibiting the flow of pressurized liquid concentrate and pressurized diluent from the dispensing assembly to produce the beverage.

12. The method of claim 11 further comprising providing the concentrate container containing liquid coffee concentrate, and further comprising introducing the diluent in the tank and wherein the diluent comprise water.

13. The method of claim 11 further comprising an air pump for pressurizing the air in the airtight enclosure.

14. The method of claim 11 further comprising providing a pump to pressurized diluent.

15. The method of claim 11 further comprising adjusting a rate of flow of the liquid concentrate to produce the beverage.

16. The method of claim 11 further comprising maintaining a predetermined temperature of the diluent in the tank.

17. The method of claim 11 further comprising heating the diluent in the tank to an elevated temperature.

18. The method of claim 11 further comprising directing diluent through the concentrate conduit to clean a concentrate conduit.

19. The method of claim 11 further comprising providing a cleaning valve for directing diluent through the concentrate conduit to clean the concentrate conduit.

20. The method of claim 11 further comprising providing a cleaning valve having a first position for permitting discharge of liquid concentrate and diluent from a discharge outlet to produce the beverage, and a second position where discharge from the discharge outlet is inhibited and diluent is directing through a concentrate conduit.

21. The method of claim 11 further comprising providing a cleaning valve, and wherein the cleaning valve has a cutout which when the cleaning valve is rotated and aligned in a first position connects a passageway in the dispensing assembly to a discharge outlet to permit discharge of liquid concentrate and diluent from a discharge outlet to produce the beverage, and when rotated and disposed in a second position, discharge from the discharge outlet is inhibited and diluent is directing through a concentrate conduit.

22. The method of claim 11 further comprising providing a solenoid valve for controlling the discharge of concentrate to a discharge outlet.

23. The method of claim 11 further comprising providing the concentrate container comprising a flexible bag.
